(19) United States
(12) Patent Application Publication
(10) Pub. No.: US 2019/0139057 A1
(43) Pub. Date: May 9, 2019

(54) SENSORIZED RETAIL ITEMS AND METHODS

(71) Applicant: salesforce.com, Inc., San Francisco, CA (US)

(72) Inventors: Youngjun Kwak, San Fernando, CA (US); Cody Henshaw, San Francisco, CA (US); Alan Dawkuan Hwang, San Fernando, CA (US)

(21) Appl. No.: 15/803,394

(22) Filed: Nov. 3, 2017

(51) Int. Cl. G06Q 30/02; G08B 1/08; G01P 15/00; H04W 4/35

(52) U.S. Cl. CPC G06Q 30/0201; H04W 4/35; G01P 15/003; G08B 1/08

(57) ABSTRACT

Sensorized packaging for a retail item includes one or more wireless acceleration, tilt, position or other sensors coupled to a processor to sense changes in position and/or orientation of the item, identify a user device associated with the changes, determine a type of interaction that caused the change, and transmit a signal identifying at least the retail item, the device associated with the change, and the type of interaction. A digital data processor that receives the signal can identify a record associated with the user device and store to that record the object identity and type of interaction.

### BACKGROUND

### Field of Technology

This pertains to remote sensing of physical items and has application, by way of example, in retailing.

An online store can capture and record clicks by consumers, and that data provides insights into customer behavior and interests. For example, if many visitors click on a specific product, an owner of the online store can infer that that the product is attracting interest and can analyze what kind of demographics are behind that interest. Such tracking is not possible in physical (a/k/a “brick-and-mortar” or “offline” stores). This limits access to highly valuable data and, by way of example, the ability of brands and/or retailers to provide unified commerce experience across the online and offline channels.

### BRIEF DESCRIPTION OF THE DRAWINGS

A more complete understanding of the discussion that follows may be attained by reference to:

FIG. 1, which depicts an illustrative embodiment and an environment in which it is employed;

FIG. 2, which depicts operation of an embodiment shown in FIG. 1.

### DETAILED DESCRIPTION OF THE ILLUSTRATED EMBODIMENT

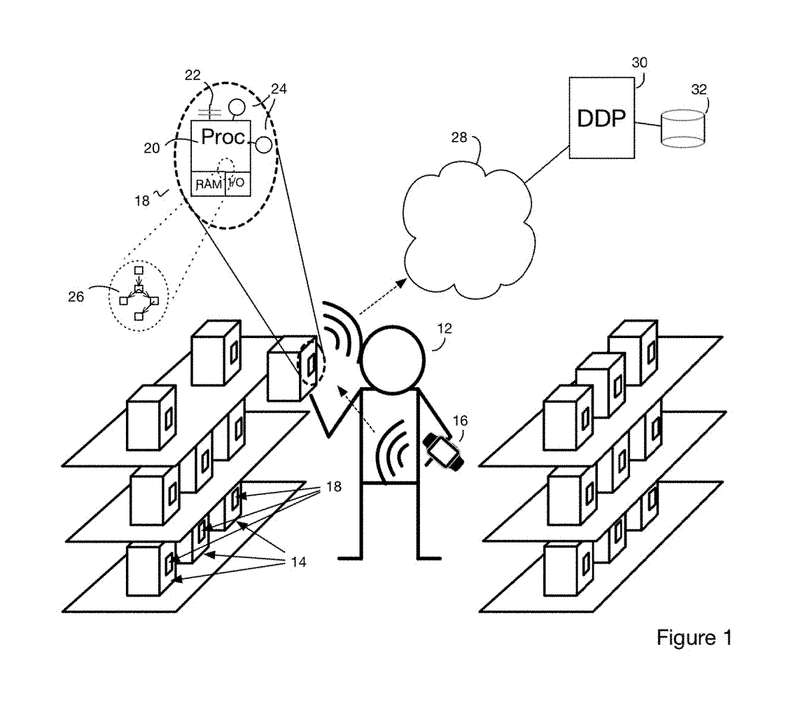

FIG. 1 depicts a physical retail space 10 of the type in which an embodiment is employed. This may be a brick-and-mortar store, an indoor bazaar, an outdoor market, or so forth, in which an individual 12 picks up, inspects, tries, or otherwise interacts with physical retail items 14—eighteen of which are shown in the drawing, though, to avoid clutter, only three of which are labelled. The items 14, which may be of any type made available for sale or otherwise in retailing, are depicted in packaging in the illustrated embodiment, though none need be provided in this and other embodiments. And, though the items 14 are depicted as identical it will be appreciated that they need not be. The individual 12, which may be a customer, a retail employee or other, is referred to hereinafter without loss of generality as “user” 12.

Disposed on user 12 is a device 16—here, a personal digital assistant in the form factor of a “smart” watch of the type known and operating in accord with the art as adapted in accord with the teachings hereof. In other embodiments, the device 16 may be another manner of personal digital assistant, e.g., a cell phone, an electronic bracelet, a contactless loyalty card, or other wirelessly-detectable device that is disposed in, on, or about the user 12 and by which he/she may be distinguished (directly or indirectly) from other individuals (also bearing such devices) who may be present in space 10. Such user devices may be of the type known in the art and operating (actively, passively or otherwise) in accord therewith as adapted in accord with the teachings hereof.

Disposed on retail items 14 are wireless IoT sensors of the type known in the art as adapted in accord with the teachings hereof. Eighteen such sensors 18 are shown identically on respective items 14 in the drawing; to avoid clutter, only three are labelled. Each sensor 18 comprises a processor 20, antenna 22 and one or more sensor elements 24, shown in breakout by way of example in the upper left of the drawing. The elements 20-22 on a given retail item 14 may be separate but interconnected with one another or they may be integrated onto a single circuit board (flexible or otherwise) or on a single chip (e.g., as in the case of a SoC, or system on a chip, implementation), or otherwise. IoT sensors 18 can be disposed on or in the respective items 14; this is referred to herein as “on” for simplicity and without loss of generality.

Sensor elements 24 of IoT sensor 18 are of the type known in the art for any of optical, acceleration, tilt, force, load, torque, strain, pressure, position, presence, motion, velocity, displacement, temperature, acoustic, sound, vibration or other sensing, as selected and adapted in accord with the teachings hereof. The elements 24 are employed, here, to sense changes in position and/or orientation of the item 14 on which they are disposed. Though two elements 24 are shown in the breakout, a greater or lesser number of them may be provided in other embodiments.

The processor 20, which can include or be coupled with random access memory and input/output subsections, may be of the type known in the art for use in an IoT sensor as adapted in accord with the teachings hereof, e.g., through loading and execution of software 26, discussed below.

Antenna 22 can be of the conventional type known in the art for use with IoT sensors. This can be configured for use, along with processor 20 or other logic, to wirelessly transmit information signals utilizing WiFi, Bluetooth, ZigBee, 2G/3G/4G cellular, or other protocols known in the art as adapted in accord with the teachings hereof. As indicated by wavefronts in the drawing, antenna 22 (and the IoT sensor 18 of which it forms a part) wirelessly communicates with user device(s) 16 as well as with digital data processor 30. Communications with the latter are additionally supported by network 28, which comprises one or more conventional networks local area networks (LANs), wide area networks (WANs), metropolitan area networks (MANs), and or Internet(s) suitable for supporting communications between IoT sensor 18 and digital data processor 30.

Digital data processor 30 comprises a conventional desktop computer, workstation, minicomputer, laptop computer, tablet computer, PDA, mobile phone or other digital data device of the type that is commercially available in the marketplace as adapted in accord with the teachings hereof. It may be configured as, coupled to, and/or provide a database system (including, for example, a multi-tenant database system) that includes disk or other storage 32, or other system or environment, and it may be arranged to communicate with IoT sensors 18 in peer-to-peer fashion, per a client-server model, or otherwise, consistent with the teachings hereof.

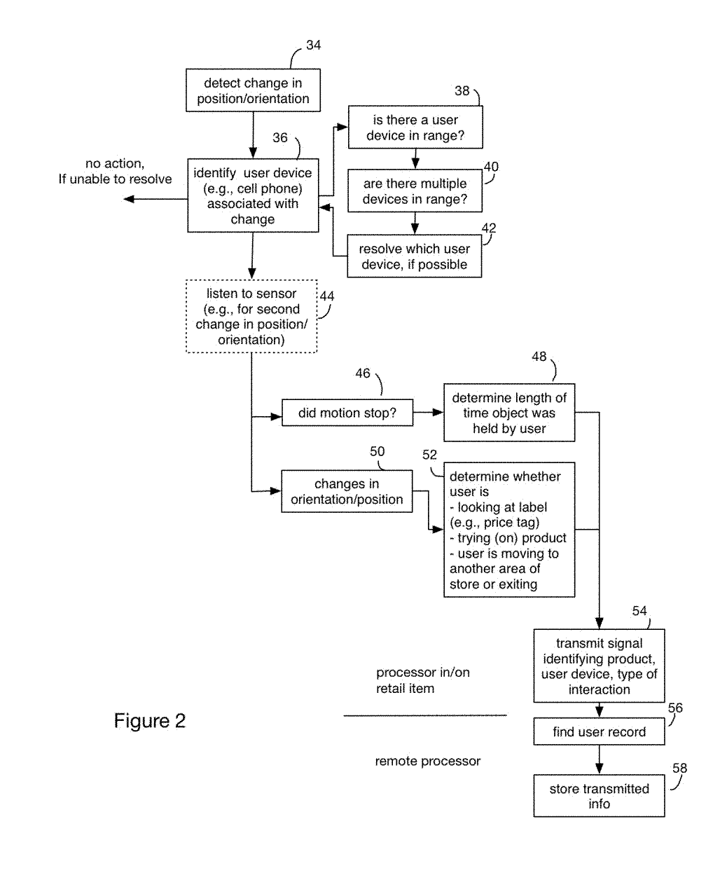

FIG. 2 depicts a method executed by IoT sensor 18—and, specifically, by software 26 executing on processor 20 of that sensor 18—to identify physical interactions between the user 12 and the retail item 14 on which that sensor 28 is disposed. In the illustrated embodiment, that can include, by way of example, picking up, inspecting labels (e.g., price tags), or moving the item 14. Other embodiments may contemplate identification of other interactions, instead or in addition.

The software 26 comprises computer programs (i.e., sets of computer instructions) stored on transitory and non-transitory machine-readable media of the type known in the art as adapted in accord with the teachings hereof, which computer programs cause the sensor 18 and, more particularly, the respective processor 20 thereof, to perform the respective operations and functions attributed thereto herein. Such machine-readable media can include, by way of non-limiting example, hard drives, solid state drives, and so forth, coupled to the respective sensor 18 and processor 20 directly or indirectly (e.g., via network 28) in the conventional manner known in the art as adapted in accord with the teachings hereof.

In step 34, the software 26 detects a change in position and/or orientation of the item 14 in which that software 26 is executing. This can be by monitoring one or more of the respective sensor elements 24 (e.g., a tilt and/or motion sensor element) disposed in that item 14 and/or by responding to an interrupt or other event signaled by such element(s) 24, or otherwise as within the ken of those skilled in the art in view of the teachings hereof.

In step 36, the software 26 identifies a user device 16 (and thereby, indirectly, its user 12) associated with the change of position/orientation of the item 14 in which that software is executing. This can be by querying signals received by one or more of the respective sensor elements 24 (e.g., a wireless transmitter sensor) disposed in that item, by monitoring incoming transmissions received on antenna 22 of that item 14, or otherwise as within the ken of those skilled in the art in view of the teachings hereof, to determine whether there is a device 16 in sufficiently close range to be likely associated with a user 12 responsible for the change in position/orientation. See step 38. That range can be as little as 1-foot, by way of example, to insure that only a watch 16 on the arm of a responsible user 12 is detected, or as much as 10- to 15-feet or more, by way of further example, to detect a cell phone owned by that user 12 disposed in a nearby shopping cart, all in accord with the demands of the embodiment and environment in which it is utilized.

The identification determined in step 36 can be any manner of identification associated with the device 16 from which the identity of its user 12 can be discerned (directly or indirectly) by specific individual, by population segmentation, classification or otherwise. In some embodiments, the user devices 16 execute general- or special-purpose software causing them to generate signals from which their user's respective identity can be more readily determined, e.g., upon transmission to digital data processor 30.

In the event the software 26 detects multiple user devices 16 within range, it attempts to resolve which of those devices is most likely associated with a user 12 responsible for the change in the position/orientation of the item 14 in which that software is executing. This can be by comparing the strength of signals received from the multiple devices 16 at one or more of the respective sensor elements 24, at the antenna 22 of that item 14, or otherwise as within the ken of those skilled in the art in view of the teachings hereof. If the software 26 is able to resolve among multiple user devices, it discerns an identification of the type discussed above associated with the device 16 most likely associated with the change in position/orientation.

If the software 26 is unable to identify a specific user device 16 associated with the change of position/orientation, it takes no further action. Otherwise, processing progresses to optional step 44, where the software 26 monitors for further changes in position/orientation and/or a cessation in same. The software 26 performs such further monitoring in the manner discussed above in connection with step 34 or otherwise as within the ken of those skilled in the art in view of the teachings hereof.

In steps 46-48, the software 26 responds to a cessation of motion by determining the length of them that the item 14 was held for inspection or otherwise by user 12. This can be by comparing the time the change in position/orientation was first detected (in step 34) with the time it stopped (in step 44) or otherwise as within the ken of those skilled in the art in view of the teachings hereof.

Alternatively, or in addition, in steps 50-52, the software responds to further changes in the position/orientation of the item 14 in which that software 26 is executing by determining what sort of interaction the user 12 is engaged in with the item 14. That can include, for example, determining whether the user is trying (e.g., trying on) the item 14, looking at a price tag or other label on the item 14, moving the item 14 within the retail space 10 or otherwise. The software makes the determination by comparing the changes detected in steps 24 and 34 with patterns characteristic of those types of interactions.

In step 54, the software 26 transmits to network 28, e.g., for routing to digital data processor 30, one or more of the identity of the item 14 in which the software 26 is executing, the identity of the user device 12 determined in step 36, and the duration and/or type of interaction determined in steps 48, 52.

Steps 56 and 58 of FIG. 2 are executed by software executing in the conventional manner (albeit as adapted in accord with the teachings hereof) on digital data processor 30. In step 56, that software accesses (or creates) a database 32 record for the user, user segment or user classification identified in the signal transmitted in step 54 and, in step 58, updates that record with the duration and/or interaction-type information transmitted in that signal. The record, so updated, can inform further marketing, product development or other actions with respect to item 14 with which the user 12 interacted.

The embodiments above are merely illustrative Other embodiments are contemplated, as well. For example, although in the embodiment of FIG. 2, steps 42 and 52, by way of non-limiting example, are effected by processing performed by software 26 executing on the item 14 with which the user 12 was interacting, in other embodiments, that processing can be performed on digital data processor 30 (based on information transmitted thereto by item 14) or by other digital data processing apparatus, as is within the ken of those in the art in view of the teachings hereof.

What we claim is:

1. A method of identifying interactions with a retail item, comprising
sensing a first change in any of a position and/or orientation in a physical retail item that is disposed in a physical retail space,
identifying a device associated with the first change,
determining a type of interaction with the item that caused the first change,
transmitting a signal identifying at least one of the item, the device and the type of interaction.

2. The method of claim 1, the sensing step comprising sensing the first change with a wireless sensor disposed any of in and on the item.

3. The method of claim 2, the sensing step comprising sensing the first change with a wireless IoT sensor.

4. The method of claim 3, the sensing step comprising sensing the first change with a wireless IoT sensor that includes any of an optical, acceleration, tilt, force, load, torque, strain, pressure, position, presence, motion, velocity, displacement, temperature, acoustic, sound, or vibration sensor.

5. The method of claim 2, the identifying step comprising identifying, as said device, one is disposed in a vicinity of the item.

6. The method of claim 5, the identifying step comprising identifying, with a wireless sensor that is disposed any of in and on the item, a said device disposed in the vicinity of the item.

7. The method of claim 2, the transmitting step comprising transmitting the signal with a wireless transmitter that is disposed any of in and on the item.

8. The method of claim 2, comprising sensing a second change in any of the position and/or orientation of the physical retail item.

9. The method of claim 8, comprising sensing the second change with the wireless sensor as sensed the first change.

10. The method of claim 8, the determining step comprising determining any of a type and a duration of the interaction based on the first and second changes.

11. The method of claim 10, the determining step comprising determining the interaction is an inspection any of the the item and a label thereon.

12. The method of claim 10, the determining step comprising determining the interaction is a trying of the item.

13. The method of claim 10, the determining step comprising determining the interaction is a movement of the item any of within or from the physical retail space.

14. The method of claim 1, the identifying step comprising identifying any of a cell phone and digital assistant associated with the first change.

15. The method of claim 1, the identifying step comprising
sensing multiple devices in a vicinity of the item,
resolving among the multiple devices to identify a one of them associated with the first change.

16. The method of claim 1, comprising
receiving the transmitted signal and recording at least one of the item, the selected device and of the type of interaction identified therein.

17. The method of claim 16, the receiving step comprising receiving the transmitted signal in a digital data device disposed remotely from the item.

18. The method of claim 17, comprising
identifying an record associated with selected device, and
the recording step including recording at least one of the item and the type of interaction to the record.

19. Computer instructions configured to cause a digital data device to:
sense, with a wireless sensor disposed any of in and on a physical retail item that is disposed in a physical retail space, a first change in any of an position and/or orientation in the item,
identify a device associated with the first change,
determine a type of interaction with the item that caused the first change transmit a signal identifying at least one of the item, the device and of the type of interaction.

20. The computer instructions of claim 19, further configured to cause the digital data device to sense, with the wireless sensor, the second change in the position and/or orientation of the item.

21. The computer instructions of claim 20, further configured to cause the digital data device to determine any of a type and a duration of the interaction based on the first and second changes.

22. A manufacture for use with a physical retail item, the manufacture comprising
one or more wireless sensors,
a processor that is coupled to the sensor(s), the processor
sensing a first change in any of an position and/or orientation in a physical retail item that is disposed in a physical retail space,
identifying a device associated with the first change,
determining a type of interaction with the item that caused the first change,
transmitting a signal identifying at least one of the item, the device and of the type of interaction.

23. The manufacture of claim 22, the processor sensing a second change in the position and/or orientation of the item.

24. The manufacture of 23, the processor determining any of a type and a duration of the interaction based on the first and second changes.
